(19) United States
(12) Patent Application Publication
(10) Pub. No.: US 2017/0030012 A1
(43) Pub. Date: Feb. 2, 2017

(54) THREAD, AND ASSOCIATED EQUIPMENT PIECE OF A VEHICLE, FORMATION PROCESS TO MAKE A THREAD AND FABRICATION METHOD FOR MAKING A PIECE OF AUTOMOTIVE VEHICLE

(71) Applicant: Faurecia Automotive Industrie, Nanterre (FR)

(72) Inventors: Xavier BATHELIER, Saint Pierremont (FR); Steve JEUNESSE, Mouzon (FR); Valérie MARCEL, Brandeville (FR)

(21) Appl. No.: 15/221,084

(22) Filed: Jul. 27, 2016

(30) Foreign Application Priority Data
Jul. 28, 2015 (FR) 15 57208

(51) Int. Cl. D06M 15/248; B32B 5/26; B32B 27/12; D01D 5/12; B32B 7/12; B32B 5/02; D01F 6/62

(52) U.S. Cl. CPC D06M 15/248; B32B 5/024; B32B 5/022; B32B 5/26; D01F 6/62; D01D 5/12; B32B 7/12; B32B 27/12; B32B 2250/20; B32B 2255/02; B32B 2255/26; B32B 2262/12; B32B 2262/0284; B32B 2262/0238; B32B 2307/102; B32B 2307/584; B32B 2307/73; B32B 2605/003; D06M 2101/32

(57) ABSTRACT

A thread intended to be woven. The thread includes a core made of a polymer, and a sheath covering the core. The sheath is formed of polyvinyl chloride (PVC). The thread individually presents, at 130° C., an elongation at maximal force, such as measured with the D411099 standard, greater than or equal to 20%.

### TECHNICAL FIELD

The present invention relates to a thread comprising:

a core comprising a polymer, and

a sheath covering the core, the sheath comprising polyvinyl chloride (PVC).

### BACKGROUND

Coatings of floors of present automobile vehicles are estimated to be able to get dirty, to be not very resistant to abrasion and cleanable with difficulty. They require the addition of carpet mats or plastic heel-pieces.

Further, there exists a need for a thermosettable inexpensive coating having a controlled acoustic absorption.

Present floorings are generally made from “tufted” products consisting of a non-woven substrate of the so-called “spunbonded” type and of threads making up a velvet, or else needled products generally made on machines of the Dilour® type. These products may easily be formed, i.e. they may be deformed for fitting an even complex shape, either at room temperature or under the effect of heat (they are then more specifically designated as thermosettable) but have limited properties in terms of resistance to abrasion and may get dirty and are washable with difficulty.

Another class of flooring, mostly intended for utility vehicles, is formed by polyolefin thermoplastics (POTs) which are thermosettable plastic materials in the form of films. These materials although easily washable do not have a very pleasant aspect. Further as these materials are not porous, unlike the textile floorings mentioned above, they do not participate in the acoustic comfort of the vehicle when the latter is based on acoustic absorption, i.e. on the attenuation of sound by dissipation of the acoustic waves in a porous material.

Moreover fabrics are known, based on threads comprising a polyvinyl chloride (PVC) sheath and a semi-crystalline polyethylene terephthalate (PET) core. By semi-crystalline PET is meant PET for example having a crystallinity level greater than 35%. Such threads give the possibility of producing a solid and non-deformable fabric. These fabrics are adapted to the flooring in the field of dwellings and outdoor applications because of their resistance to water, of their resistance to abrasion and to their large dimensional stability. Further, the PET core has a resistance to elongation facilitating weaving of the thread.

Document FR2 617 205 describes the making of a thread of the aforementioned type. In order to produce the thread, PET core passes into a plastisol bath with high viscosity. The core carries away on its perimeter a certain amount of plastisol. It then passes into a die which allows calibration of the amount of plastisol in order to form a sheathed thread with a regular section. The sheathed thread is heated to between 180 and 200° C. in order to gel the plastisol. The gelling is an irreversible operation where the PVC molecules interact through the plasticizer network. The semi-crystalline PET core thread, for which the melting temperature is located around 250° C., is not altered by the temperature of 200° C.

Another method also described in FR 2 617 205 consists of extruding the PVC around the core thread still in PET. In this case, the core thread crosses a die used for extruding a plasticized thermoplastic PVC. The extrusion temperature of the thermoplastic PVC, located around 140° C., is less than the melting temperature of the PET which is therefore not at all altered.

A set of sheathed threads thereby produced by either one of these methods is woven conventionally in order to form a fabric generally along rather simple weaves: plain or twill weaves.

The elongation at the maximum force, sometimes called the elongation at maximum load, and the Young modulus of the semi-crystalline PET are high, further the semi-crystalline PET is not very sensitive to humidity. The semi-crystalline PET core thus gives excellent dimensional stability to the sheathed threads as well as to the products consisting of such threads.

Thus, this type of fabric has many advantages which would lead to the possibility of contemplating it in an automotive context. These fabrics have a pleasant aspect because of their structure. Further, it is possible to obtain such fabrics in various colorations since the PVC sheath may accept any type of pigments. Further, it is possible to obtain such fabrics with adapted porosity compatible with an acoustic treatment based on absorption. Further such fabrics have great resistance to abrasion, washability.

However, as such fabrics are not deformable, they are not adapted to the making of automobile vehicle parts, for example floorings.

Indeed, the floor of an automobile vehicle having a complex shape, the coating, for fitting this shape, has to be deformable or thermosettable.

Moreover, the floorings are associated with other products commonly called “sub-layers”, like heavy masses (a strongly loaded thermoplastic film having a high density) or optionally felts (set of fibers making up a porous highly acoustically absorbent medium) for acoustic reasons and/or in order to give them sufficient stiffness which will allow them to be rapidly positioned in the vehicle on the production lines.

These sub-layers are thermosettable. They should be generally heated to a temperature of the order of 130°-160° C. The associated coatings therefore have to be thermosettable at this same temperature. This is not the case of the fabric of sheathed threads presented in FR 2 617 205.

Indeed, even if the temperature for softening the PVC sheath is less than 130° C., as the plasticized PVC is generally malleable from 80° C., the softening temperature of the semi-crystalline PET is of the order of 230° C., the fabric is therefore not thermosettable at a temperature below 200° C.

The non-formability and the non-thermosettability at temperatures below or equal to 160° C., for example 130° C. of the fabric formed with semi-crystalline PET threads makes it therefore impossible to shape them for use in the context of automobile floorings.

### SUMMARY

An object of the invention is to provide a sheathed thread with improved properties of use, but compatible with the forming processes dedicated to automotive floorings.

For this purpose, described herein is a thread of the aforementioned type which individually has at 130° C. an elongation at the maximum force as measured by the D411099 standard greater than or equal to 20%.

The thread according to at least some embodiments of the invention may comprise one or several of the following features taken individually or according to all the technically possible combinations:

the polymer of the core has a softening point of less than or equal to 130° C.,

the core comprises at least one polymer selected from the group formed by polyethylene (PE), polypropylene copolymer (coPP), polypropylene (PP) and polyethylene terephthalate PET and its copolymers (coPET),

the polymer of the core has a crystallinity level greater than 1% and less than 30%, the core preferably consisting of polyethylene terephthalate (PET) partly stretched,

the sheath has a thickness of more than 0.15 mm, preferably greater than 0.175 mm and advantageously comprised between 0.175 mm and 0.30 mm, preferably comprised between 25% and 35% of the diameter of the thread,

the core consists of a spun-bonded polymer with fibers or filaments, the number of filaments being advantageously comprised between 2 and 100.

An object of the invention is also to provide a piece of automobile vehicle equipment comprising:

a wall comprising a polymer-based matrix,

a fabric, the fabric comprising an upper face intended to be oriented towards a passenger compartment of the vehicle and an opposite face attached on the wall, the fabric fitting the shape of the wall, and the fabric consisting of threads as described earlier.

The piece of automobile vehicle equipment according to one or more embodiments of the invention may comprise one or several of the following features taken individually or according to all the technically possible combinations:

the piece further comprises a stabilizing element attached on the wall and/or on the fabric, the stabilizing element advantageously comprising a non-woven of polyethylene terephthalate (PET).

the fabric has an air flow resistance (AFR) comprised between 200 N·s·m⁻³ and 2500 N·s·m⁻³.

An object of the invention is also to provide a method for forming a thread comprising a core and a sheath around the core, comprising the following steps:

providing a core, the core consisting of a polymer,

producing a sheath around the core,

the sheath comprising polyvinyl chloride (PVC), the thread having at 130° C., an elongation at the maximum force as measured by the D411099 standard greater than or equal to 20%.

The method according to at least some embodiments of the invention may comprise one or several of the following features taken individually or according to all the technically possible combinations:

the core has a melting point of less than 120° C., the method comprising the following steps:
forming a sheath by coating plastisol around the core, and
a first step for heating the thread to a temperature of less than 120 C,

the step for providing the core comprises a step for extruding the polymer of the core and a step for stretching the core following the extrusion step, the stretching of the core being less than 100%, notably less than 20%, notably less than 30% at the value leading to a crystallinity level of more than 30%.

An object of the invention is also to provide a method for making a piece of automobile vehicle equipment comprising the following steps:

providing a plurality of wires as described earlier,

weaving the threads, resulting in a fabric,

providing a wall,

thermosetting of the fabric and of the wall at a temperature of less than or equal to 130° C., so that the fabric fits the shape of the wall.

The method according to one or more embodiments of the invention may comprise one or several of the following features taken individually or according to all the technically possible combinations:

the method comprises the step of attaching a non-woven stabilizing element on the wall and/or on the fabric, the stabilizing element advantageously comprising a non-woven of polyethylene terephthalate (PET),

the step for attaching a non-woven stabilizing element is applied during the thermosetting and comprises a step for adhesively bonding the non-woven stabilizing element on the wall, and/or on the fabric,

the method comprises a step for heating the fabric to 200° C. before the thermosetting step.

### BRIEF DESCRIPTION OF THE DRAWINGS

The invention will be better understood upon reading the description which follows, only given as an example, and made with reference to the appended drawings, wherein:

FIG. 1 is a sectional view, in a vertical plane, of a flooring element and of a body portion of a vehicle on which it is assembled, and

FIG. 2 illustrates a thread according to the invention.

### DETAILED DESCRIPTION OF THE ILLUSTRATED EMBODIMENTS

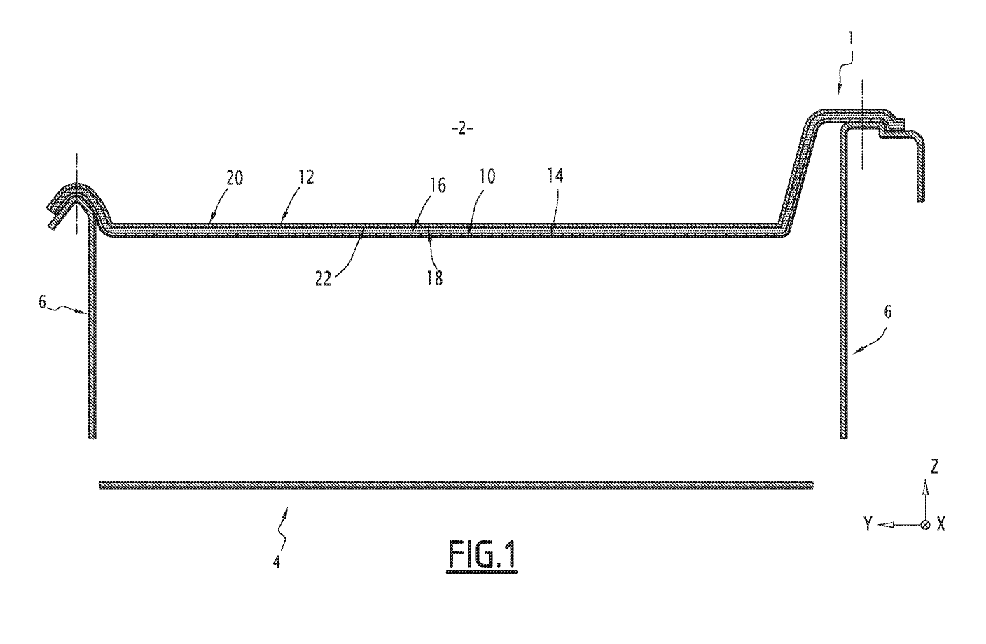

FIG. 1 illustrates an example of a piece of automobile vehicle equipment 1 according to an embodiment of the invention. The automobile vehicle equipment piece 1 is intended to be placed in a passenger compartment 2 of the vehicle.

In the example described here, the automobile vehicle equipment piece 1 is a flooring element. Alternatively, the automobile vehicle equipment piece 1 is a dashboard element, an element of the tunnel, a trim complex of a tablet, of the boot, a sound-proofing lateral trim complex, or other elements.

Tunnel is the name of the central portion of the passenger compartment, generally raised relatively to the flooring and separating the driver from the passenger.

FIG. 1 is oriented in the orthonormal reference system X, Y, Z corresponding to the normal orientation of a vehicle.

In this system of axes:

the X axis corresponds to the longitudinal axis of the vehicle, oriented in the forward direction;

the Z axis is the vertical axis oriented from bottom to top; and

the Y axis is the transverse axis of the vehicle.

In the continuation of the description, the position and orientation terms are understood with reference to this system of axes.

The automobile vehicle equipment piece 1 is positioned in the passenger compartment 2 of the vehicle.

The piece 1 has acoustic absorption or acoustic insulation characteristics so as to reduce noise disturbances. For example, the piece 1 is intended to acoustically insulate the inner passenger compartment from the engine compartment or from rolling noises.

Further, the piece 1 has dimensional stiffness and stability adapted to its use as a floor in the automobile vehicle.

In FIG. 1, the automobile vehicle equipment piece 1 is illustrated in an assembled configuration on a vehicle body. The body of the vehicle is schematically illustrated by a flooring portion of the body 4, and of the vertical edges 6, consisting of body portions formed with the flooring 4 or of the stringers secured to the body.

The automobile vehicle equipment piece 1 is for example a flooring comprising a dual-shell structure.

The automobile vehicle equipment piece 1 comprises a wall 10 and a fabric 12, visible from the passenger compartment 2, the wall 10 forming the sub-layer of the fabric 12. The piece of equipment 1 further includes a stabilizing element 14 positioned opposite to the fabric 12 on the wall 10.

The wall 10 delimits an upper face 16 intended to be oriented towards the passenger compartment 2 of the vehicle and an opposite face 18. The wall 10 for example advantageously has a thickness comprised between 3 mm and 6 mm.

The wall 10 is for example one of the shells of the dual-shell structure, another shell being a planar wall located under the wall 10 and defining with the wall 10 a cavity.

The wall 10 for example has a shape with raised/recessed portions.

The wall 10 comprises a polymer-based matrix. For example, the wall 10 is formed with the remainder of the dual-shell structure.

The wall 10 is advantageously able to be thermoset at 130° C.

The wall 10 is for example made on the basis of at least one polyolefin, for which the melting temperature is less than 160° C. and for which the softening temperature is substantially 130° C. For example, the wall is based on polypropylene (PP) or on ethylene-vinyl acetate (EVA).

For example, the wall 10 is a heavy mass layer.

The heavy mass layer is formed on the basis of a polymeric matrix containing fillers. The polymer of the heavy mass is in the amorphous state.

Alternatively, the wall 10 is a felt.

The stabilizing element 14 is able to ensure dimensional stability of the complex.

In FIG. 1, the stabilizing element 14 is placed under the opposite face 18 of the wall 10. Alternatively, the stabilizing element 14 is placed on the upper face 16 of the wall 10 and under the fabric 12. The stabilizing element 14 is for example attached to the wall 10 or to the fabric 12 by adhesive bonding.

The stabilizing element 14 advantageously comprises a non-woven. The non-woven advantageously comprises non-woven PET fibers. The non-woven PET fibers are made in PET in the semi-crystalline state in order to ensure the textile properties of resistance to stretching and of dimensional stability. The stabilizing element 14 may be formed, i.e. it is deformable even at room temperature, by sliding of the PET fibers relatively to each other under the effect of stretching. However, the PET fibers of the non-woven, after heating to 130° C. retain all their textile properties of resistance to stretching and of dimensional stability. Once they are adhesively bonded against the wall 10 and/or the fabric 12 in the finished piece 1 after thermosetting, the non-woven-PET fibers are no longer mobile and fully ensure their role of a stabilizing, such as the reinforcement fibers in a composite.

In an alternative, when the wall 10 is a felt, the stabilizing element 14 is an amount of PET fibers integrated into the felt.

The fabric 12 is positioned above the upper face 16 of the wall 10. The fabric 12 is visible from the passenger compartment 2 of the vehicle.

The fabric 12 comprises an upper face 20 intended to be oriented towards a passenger compartment 2 of the vehicle and an opposite face 22 attached on the wall 10. The fabric 12 fits the shape of the wall 10.

The fabric 12 is able to be thermoset at 130° C.

The fabric 12 consists of a plurality of threads 30. The fabric 12 advantageously comprises weft and warp threads woven together.

The threads 30 and the method for forming the threads 30 will be described in more detail subsequently.

The fabric 12 is both porous and resistant. The weave, the diameter and the tightening of the threads 30 of the fabric 12 are adapted so as to have the desired porosity and the desired strength.

The number of threads 30 per cm of fabric 12 in the weft direction as well as in the warp direction is comprised between 6 and 12.

The air flow resistance of the fabric 12 (AFR) measured according to the ISO 9053 standard is comprised between 200 N·s·m⁻³ and 2500 N·s·m⁻³.

The porosity of the fabric 12 gives the automobile vehicle equipment piece 1 improved acoustic absorption properties as compared with absorbing felts used alone.

The fabric 12 has a particularly improved abrasion resistance as compared with tufted or needled carpet mats, customarily used in vehicles.

Further, in an example, the fabric 12 is provided with an additional layer, giving it other properties, such as for example improved resistance to friction and abrasion.

For example, the additional layer of the fabric 12 is a polyurethane (PU) varnish giving the possibility of limiting the emissions of materials such as plasticizers from the sheath based on PVC. Advantageously, the varnish is able to be heated to 130° C. without undergoing any degradation.

With the great resistance to friction which the additional layer based on polyurethane gives the fabric 12, it is possible to avoid the addition of heel-pieces, for example under the pedals of the vehicle.

In the same way, the simplicity of maintenance and cleaning of this fabric 12 makes the use of “carpet-mats” unnecessary, i.e. removable carpet pieces giving the possibility of limiting fouling of the carpet and of simplifying the cleaning of the passenger compartment.

The fabric 12 is anti-dust, i.e. it is capable of preventing the dust present in the passenger compartment 2 and regularly settling on the floor to be retained on the fabric 12. Further, the fabric 12 is able to prevent the proliferation of mites responsible for allergens.

For example, the weft threads and the warp threads are identical.

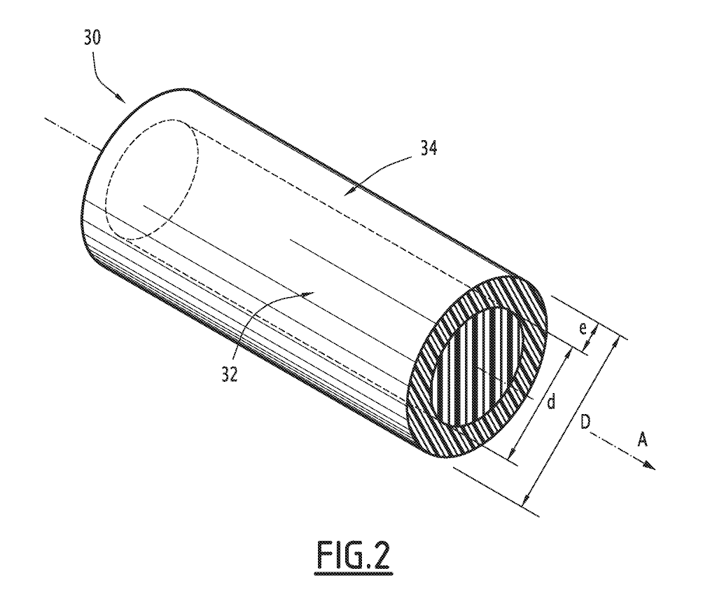

A thread 30 will now be described with reference to FIG. 2.

The thread 30 comprises a core 32 and a sheath 34 covering the core 32.

Each thread 30 individually has at 130° C., an elongation at the maximum force as measured by the D411099 standard of the car manufacturer Renault of more than or equal to 20%.

The capability of elongation of the threads at 130° C. gives the possibility of ensuring the thermosetting capability of the fabric at 130° C.

The thread 30 is elongated along a main axis A. The length of the thread 30 along the main axis A is adapted to the fabric 12.

Further, the thread 30 is resistant to weaving traction. The thread 30 advantageously has an elastic modulus measured according to the D411099 standard of the car manufacturer Renault greater than 5 GPa (Gigapascal).

The section of the thread 30 transversely to the main axis A is advantageously circular. The diameter D of the thread 30 is less than 2 mm and is advantageously comprised between 0.5 mm and 1.5 mm.

The section of the sheath 34 transversely to the main axis A is regular over the whole length of the thread 30. The section of the sheath 34 is substantially a ring. The thickness e of the sheath 30 is comprised between 50% and 80% of the diameter D of the thread 30.

The sheath 34 comprises polyvinyl chloride (PVC). Alternatively, the sheath 34 further comprises a plasticizer.

The softening point of the sheath 34 is less than 130° C.

The sheath 34 is able to prevent accumulation of dust.

The sheath 34 is secured to the core 32. The sheath 34 is for example formed by extrusion around the core 32, as this will be described subsequently.

The section of the core 32 transversely to the main axis A is regular over the whole length of the thread 30. The section of the core 32 is substantially a disc.

The diameter d of the core 32 is comprised between 20% and 30% of the diameter D of the thread 30.

The core 32 consists of a polymer. The core 32 advantageously comprises the polymer in the form of a continuous filament. Alternatively, the core 32 comprises the spun-bonded polymer with fibers or filaments.

The polymer of the core 32 has at 130° C., an elongation at the maximum force as measured by the D411099 standard of the car maker Renault greater than or equal to 20%.

The deformability of the core 32 at 130° C. is able to allow thermosetting of the fabric 12 at 130° C. as this will be described subsequently.

In a first embodiment of the thread according to the invention, the polymer of the core 32 has a softening point of less than or equal to 130° C.

In this case, the core 32 consists of at least one thermoplastic polymer for example selected from the group formed by polyethylene (PE), a copolymer of polypropylene (coPP), a polypropylene (PP) and a copolymer of polyethylene terephthalate (coPET).

The polymer of the core 22 is semi-crystalline and has a high crystallinity level. For example, for polyolefins, the crystallinity level is greater than 50%, for PETs, the crystallinity level is more than 30%. This high crystallinity level is obtained during the extrusion of the fibers or filaments by significant stretching upon exiting the die.

According to an example, the polymer of the core 32 has a melting point of less than 120° C., like notably PE or coPP.

A first method for forming a thread 30 according to the first embodiment of the invention will now be described.

The first method is a sheathing method by coating with plastisol.

The application means of the first formation method comprise a bath of plastisol, a unit for displacing the thread 30, a die, a heating means.

The plastisol bath comprises plastisol in a viscous state.

The plastisol is a mixture of plasticizer and of PVC. The viscosity of the plastisol is adapted to the first method.

The plastisol is able to undergo gelling. Gelling is an irreversible operation where the PVC molecules interact through the plasticizer network. The plastisol for example passes from a viscous state to a complete gelling state after heating through 200° C. for one minute.

Further, the plastisol is able to undergo pre-gelling before complete gelling. The pre-gelling state is an intermediate state between the glassy state and the gelling state. The pre-gelling is an irreversible operation where the PVC molecules interact through the plasticizer network. During pre-gelling, the plastisol begins to harden substantially relatively to the viscous state. In the pre-gelling state, the plastisol is cohesive but does not have the whole of the characteristics of the plastisol in the complete gelling state. Young's modulus of the plastisol in the pre-gelling state is for example less than 50% of the value of the Young's modulus of the plastisol in the complete gelling state.

The plastisol for example passes from a viscous state to a pre-gelling state after heating to a temperature of less than 120° C., for example 80° C., for one minute. Further, the plastisol passes from a pre-gelling state to a gelling state after heating to a temperature of 200° C., for example for one minute.

The displacement unit is able to set into motion the core 32 so that it dips and emerges from the bath, passes into the die and is displaced as far as the heating means at a regulated speed.

The die gives the possibility of calibrating the amount of plastisol in order to form a sheath 34 with a regular section around the core 32.

The first method comprises the provision of a core 32 having at 130° C., an elongation at the maximum force as measured by the D411099 standard of the car maker Renault greater than or equal to 20% is provided.

The first method comprises the making of a sheath 34 around the core 32, the sheath 34 comprising polyvinyl chloride (PVC).

The making of the sheath 34 around the core 32 comprises the following steps: soaking, spinning and heating.

During soaking, the core 32 is placed in the plastisol bath by the displacement unit. The core 32 is coated with plastisol in the viscous state.

During spinning, the plastisol sheath 34 of the thread 30 is calibrated by the die.

During the heating, the thread 30 is heated to a temperature strictly less than 120° C., and greater than or equal to 80° C. so that the plastisol is in a pre-gelling state.

Thus, at the end of the step for making the sheath 34, the thread 30 comprises a sheath 34 with plastisol in a pre-gelling state. Further, the thread 30 is sufficiently resistant for undergoing weaving.

A second method for forming a thread 30 according to the first embodiment of the invention will now be described.

The second method is a sheathing method by extrusion of thermoplastic PVC.

The application means of the second formation method comprise a unit for displacing the thread 30, a die, cooling means and heating means.

The unit for displacing the thread 30 is able to displace the core 32 and the sheathed thread 30. The running speed of the thread 30 is adjustable. For example, the displacement unit is able to displace the thread 30 at a speed above 1,000 m/min, notably 1,100 m/min for minimizing the presence time of the core 32 in the die.

The cooling means for example comprise a water jet with a regulated temperature.

Alternatively, the cooling means comprise a bath and a drying unit. For example, the bath is filled with water at a regulated temperature. The drying unit is for example able to dry the thread 30 advantageously with an air jet.

The cooling means are positioned close to the outlet of the die, so that the thread 30 comprising a thermoplastic PVC sheath 34 is rapidly cooled after the extrusion.

A thermoplastic formulation based on PVC is provided. The PVC-based formulation is adapted so as to have the desired viscosity in order to adhere and be carried away by the core during the extrusion. Further, the PVC formulation has a high grade.

The second method differs from the first method described earlier in that the step for making the sheath 34 includes an extrusion step, a cooling step.

During the extrusion step, the core 32 passes through a die. The extrusion is applied, for example, at a temperature of less than 120° C. in order to preserve the core 32.

Subsequently to the extrusion step, the thread 30 comprising the core 32 and a sheath 34 with the PVC-based thermoplastic formulation is cooled with the cooling means.

A method for manufacturing a piece of equipment of an automobile vehicle 1 will now be described.

The application means of the method comprise a weaving assembly, a thermosetting assembly, a heating assembly, adhesive bonding means.

The weaving assembly for example comprises an air jet loom, a rapier loom or other weaving machine.

The thermosetting assembly comprises a mold and a heating unit. The mold has the final shape of the part.

A plurality of threads 30, a wall 10 and a stabilizing element 14 as described earlier are provided.

The method comprises a weaving step, a thermosetting step and a varnishing step.

Further, when the thread 30 has been formed according to the first method, the method comprises a gelling step.

During the weaving step, the threads 30 are woven by means of the weaving assembly.

During the gelling step, the fabric 12 obtained at the end of the weaving step is placed at 200° C. This gelling step allows complete gelling of the plastisol. Advantageously, the gelling step is carried out before the thermosetting step.

During this gelling step, in the cases when the polymer of the core 32 has a melting point of less than 200° C., the polymer of the core 32 melts or undergoes at least softening. The fabric 12 obtained at the end of the gelling step is thus able to be thermoset at 130° C. Alternatively, the gelling step is carried out after the thermosetting step.

The stabilizing element 14 is adhesively bonded to the wall 10 or on the fabric 12 before the thermosetting step.

The fabric 12, the stabilizing element 14 and the wall 10 are placed in the mold. The thermosetting of the fabric 12 and of the wall 14 is applied at a temperature of less than or equal to 130° C.

During the thermosetting step, the fabric 12 and the wall 14 fits the shape of the mold. Further, the fabric 12 fits the shape of the wall 10. Further, during the thermosetting step, the fabric 12 is attached to the wall 10.

The method advantageously comprises a varnishing step. For example, the varnishing is applied at the end of the weaving step and before the thermosetting step. During the varnishing step, the additional layer is added to the fabric 12, for example by spraying and UV cross-linking. Alternatively, the additional layer is added on the finished piece 1.

A second embodiment of the thread 30 according to the invention will now be described. In this embodiment, the thread 30 differs from the thread 30 described earlier in that the polymer of the core 32 has a crystallinity level of less than 30%.

For example, the core 32 comprises partly stretched PET. This means that the core 32 includes weakly crystallized areas.

A fabric 12 formed with a thread 30 according to the second embodiment having a low crystallinity level can no longer fully ensure the textile properties in particular the dimensional stability. This is why it is advantageous to add to such a fabric 12, a stabilizing element 14, for example non-woven, the role of which will be to ensure this stability.

A first method for forming the thread 30 according to the second embodiment will now be described.

The first method for forming a thread 30 according to the second embodiment differs from the first method for forming a thread 30 according to the first embodiment in that the method comprises a method for extrusion of the core 32 and a step for “moderate stretching” of the core 32.

The extrusion of a semi-crystalline polymer, with view to producing a textile filament if the variation of specific gravity is neglected between the liquid at the outlet of the die and that of the solid filament, is governed by the equation below, which expresses conservation of mass:

(d₀)²v₀=(dₑ)²v_{b},

wherein d₀ is the diameter of the filament at the die outlet, i.e. the diameter of the holes of the die, wherein v₀ is the speed of the filament at the die outlet, wherein dₑ is the diameter of the stretched filament, and wherein v_{b} is the winding speed of the stretched filament.

The stretching v₀ is the ratio of the winding speed and of the speed of the filament at the die output v₀. For example for v₀=30 m/min, v_{b}=6,000 m/min, d₀=3 mm; dₑ=0.2 mm, which are current industrial operating conditions, the stretching will be 200.

For such a stretching of the core 32, notably in PET, and taking into account the diameter of the holes of the die, the crystallinity level of the polymer of the core 32 is optimum, notably greater than 30%.

The means for applying the first method for forming a thread 30 according to the second embodiment further comprise an extrusion assembly and a stretching assembly.

During the extrusion step, the polymer of the core 32, for example PET, is extruded so as to form an elongated and thread-shaped core 32.

Following the extrusion step, the core 32 is stretched. The stretching of the core 32 is less than 20%, notably less than 30% at the value leading to a crystallinity level of more than 30%.

The stretching of the core 32 causes partial crystallization of the polymer of the core 32 which gives the core sufficient mechanical properties (elongation strength, Young's modulus) for allowing weaving of the threads under certain conditions, but nevertheless limit the dimensional stability of the thermoset products. The association of the stabilizing element 14, a non-woven, with the fabric 12 improves the dimensional stability of the piece 1.

With this stretching level, the polymer of the core 32 has a crystallinity level of less than 20%. The crystallinity level is measured by Differential Scanning calorimetry (DSC).

The core 32 has a Young modulus of less than 3 GPa.

Further the core 32 in PET, partly stretched, has at 130° C. an elongation at the maximum force such as measured by the D411099 standard of the car maker Renault greater than or equal to 20%.

For example, the core 32 in PET, partly stretched, has an elongation at the maximum force at a temperature of 25° C. as measured by the NF EN ISO 527 standard greater than or equal to 10%.

Further, the first method for forming the thread 30 according to the second embodiment also differs from the first method for forming a thread according to the first embodiment 30 described earlier in that the heating step during the making of the sheath 34 is advantageously carried out at 200° C. The heating step thus allows complete gelling of the plastisol in one step.

A second method for forming the thread 30 according to the second embodiment will now be described.

The second method for forming a thread 30 according to the second embodiment differs from the second method for forming a thread 30 according to the first embodiment in that the method comprises a step for extruding the core 32 and a step for moderate stretching of the core 32 as described earlier.

Next, some extruded PVC is deposited around the core 32 in order to form the sheath 34, as described earlier.

For example, the extrusion of the PVC from the sheath 34, is applied, at a temperature above 100° C., for example at 140° C. Indeed, the PET core 32 allows the use of a wide range of PVCs and a high load level.

The means for applying the second method for forming a thread 30 according to the second embodiment further comprise an extrusion assembly and a stretching assembly as described earlier.

The method for making the piece 1 comprising a fabric consisting of threads according to the second embodiment differs from the making method described earlier in that the weaving operations are adapted to the tensile strength of the core 32. For example, the weaving assemblies comprise rapier looms.

The methods for making the piece 1 which have just been described with threads according to the first embodiment or according to the second embodiment therefore give the possibility of obtaining a thermosettable piece 1 at 160° C. allowing elongations in the weft direction and in the warp direction of 20%.

Nevertheless, risks have been observed from 15% of elongation of the woven threads and that the sheath of threads 30 of the fabric 12 has cracks showing the core 32 on the fabric 12.

A third embodiment of the thread 30 according to the invention will now be described. In this embodiment, the thread 30 differs from the threads 30 described earlier in that the polymer of the core 32 is a spun-bonded polymer.

The polymer of the core 32 is obtained by spin bonding and assembly of filaments. The assembly of filaments for example comprises between 2 and 100 filaments. The assembly of filaments is twisted so as to form the core 32.

Because of the number of filaments and of the torsion, the core 32 has rough portions on its external surface. The rough portions of the core reinforce the adhesion of the sheath 34 to the core 32 by hooking-up. The adhesion of the sheath 34 to the reinforced core gives the possibility of improving the distribution of the elongation forces on the sheath 34. As the forces are well distributed, the risks of cracks of the sheath 34 are reduced.

Further, for an equivalent diameter, the variation of the diameter of the core 32, during stretching of the thread is less substantial for a core 32 formed with a twisted filament than for a core 32 formed with a single continuous filament. The elongation forces on the sheath 34 related to the reduction in the diameter of the core 32 are therefore lower for threads 30 according to the third embodiment. As the forces are lower, the risks of cracks of the sheath 34 are reduced.

It is observed that a fabric 12 made on the basis of threads 30 according to the third embodiment having a spun-bonded core 32 extends as far as 10% more than a fabric 12 consisting of threads having a single-filament core 32 without having any cracks.

The third embodiment of a thread is thus advantageous when substantial elongations are contemplated.

A fourth embodiment of the thread 30 according to the invention will now be described. In this embodiment, the thread 30 differs from the thread 30 described earlier in that the sheath 34 has a thickness greater than a determined threshold value depending on the maximum contemplated stretching.

Indeed, during the stretching of the thread 30, the sheath 34 is stretched and the thickness of the sheath 34 is reduced. The initial thickness of the sheath is therefore selected so that the thickness of the sheath 34 of the thread 30 under determined stretching is greater than a threshold value. For given stretching, the threshold value is the value of thickness below which the sheath 34 would exhibit cracks.

The thickness of the sheath is for example greater than 0.15 mm, preferably greater than 0.175 mm and advantageously comprised between 0.175 and 0.30 mm, preferably comprised between 25% and 35% of the diameter of the thread 30.

The substantial thickness of the sheath reduces the risks of cracks at the sheath 34.

The embodiments of the invention which have just been described provides a sheathed thread 30 compatible with the forming methods dedicated to automobile floorings. Indeed, the fabric 12 of the sheathed threads 30 becomes formable at the temperatures of use which allows association with the other elements of the part. The part is resistant to abrasion, has good dimensional stability and is easily washable, which avoids the addition of carpet mats and heel-pieces. Further, the fabric 12 has acoustic characteristics allowing good soundproofing.

1. A thread intended to be woven comprising:
a core comprising a polymer, and
a sheath covering the core, the sheath comprising polyvinyl chloride (PVC),
wherein the thread individually has, at 130° C., an elongation at the maximum force, as measured according to standard D411099, greater than or equal to 20%.

2. The thread according to claim 1, wherein the polymer of the core has a softening point less than or equal to 130° C.

3. The thread according claim 1, wherein the core comprises at least one polymer selected from the group formed by polyethylene (PE), copolymer of polypropylene (coPP), polypropylene (PP) and polyethylene terephthalate (PET) and its copolymers (coPET).

4. The thread according to claim 1, wherein the polymer of the core has a crystallinity level greater than 1% and less than 30%,

5. The thread according to claim 4, wherein the core consists of partly stretched polyethylene terephthalate (PET).

6. The thread according to claim 1, wherein the sheath has a thickness of more than 0.15 mm.

7. The thread according to claim 6, wherein the sheath has a thickness comprised between 25% and 35% of the diameter of the thread.

8. The thread according to claim 1, wherein the core consists of a spun-bonded polymer with fibers or filaments, the number of filaments being comprised between 2 and 100.

9. A piece of equipment of an automobile vehicle comprising:
a wall comprising a polymer-based matrix, and
a fabric, the fabric comprising an upper face intended to be oriented towards a passenger compartment of the vehicle and an opposite face attached on the wall, the fabric fitting the shape of the wall, and the fabric consisting of threads according to claim 1.

10. The piece according to claim 9, further comprising a stabilizing element attached on the wall and/or on the fabric.

11. The piece according to claim 10, wherein the stabilizing element comprises a non-woven of polyethylene terephthalate (PET).

12. The piece according to claim 9, wherein the fabric has an air flow resistance (AFR) comprised between 200 N·s·m⁻³ and 2500 N·s·m⁻³.

13. A method for forming a thread comprising a core and a sheath around the core, comprising the following steps:
providing a core, the core consisting of a polymer,
producing a sheath around the core, the sheath comprising polyvinyl chloride (PVC), the thread having at 130° C., an elongation at the maximum force, as measured according to standard D411099, greater than or equal to 20%.

14. The method according to claim 13, wherein the core has a melting point of less than 120° C., the method comprising the following steps:
sheathing by coating plastisol around the core, and
a first step for heating the thread to a temperature of less than 120° C.

15. The method according to claim 13, wherein the step for providing the core comprises a step for extruding the polymer of the core and a step for stretching the core following the extrusion step, the stretching of the core being less than 100%.

16. The method according to claim 15, wherein the stretching of the core is less than 20%.

17. The method according to claims 15, wherein the stretching of the core less than 30% at the value leading to crystallinity level greater than 30%.

18. A manufacturing method for making a piece of equipment of an automobile vehicle comprising the following steps:
providing a plurality of threads according to claim 1,
weaving the threads, resulting in a fabric,
providing a wall, and
thermosetting the fabric and the wall at a temperature of less than or equal to 130° C., so that the fabric fits the shape of the wall.

19. The manufacturing method according to claim 18, comprising the following step:
attaching a non-woven stabilizing element on the wall and/or on the fabric, the stabilizing element advantageously comprising a non-woven of polyethylene terephthalate (PET),
and wherein, preferably, the step for attaching a non-woven stabilizing element is applied during the thermosetting and comprises a step for adhesively bonding the non-woven stabilizing element on the wall and/or on the fabric.

20. The manufacturing method according to any of claim 18, comprising a step for heating the fabric to 200° C. before the thermosetting step.
